(19) United States
(12) Patent Application Publication
(10) Pub. No.: US 2018/0211324 A1
(43) Pub. Date: Jul. 26, 2018

(54) DYNAMIC ADJUSTMENT OF AN ANNUITY BASED ON WELLNESS MONITORING OF A PARTICIPANT

(71) Applicant: Discovery Limited, Sandton (ZA)

(72) Inventor: Kenneth Steven Rabson, Glenhazel (ZA)

(73) Assignee: Discovery Limited, Sandton (ZA)

(21) Appl. No.: 15/925,675

(22) Filed: Mar. 19, 2018

Related U.S. Application Data
(63) Continuation-in-part of application No. PCT/IB2016/055489, filed on Sep. 15, 2016.

(30) Foreign Application Priority Data
Sep. 17, 2015 (ZA) 2015/06942

(51) Int. Cl. G06Q 40/06; G06Q 20/22

(52) U.S. Cl. CPC G06Q 40/06; G06Q 20/22

(57) ABSTRACT

A computer-implemented method, system and computer program product for dynamic adjustment of an annuity based on wellness monitoring of a participant is described. Investment data is accessed including capital amount data relating to a capital amount to be invested for the person, investment selection data relating to an investment selection of how the capital amount is to be invested, and periodic payment amount relating to the selected periodic payment amount to be paid to the person. Wellness programme data is accessed from a variety of sources relating to a compliance of the person with a wellness programme, including a heart rate derived from a heart rate monitor worn by the person, results of health check-ups of the person, a recorded amount and location of exercise of the person, and results of preventative screening of the person. This wellness programme data is used to dynamically calculate an additional payment amount.

### CROSS-REFERENCE TO RELATED APPLICATION

This patent application is a continuation application of PCT Application No. PCT/IB2016/055489, filed on Sep. 15, 2016, which claims priority from South African Patent application Ser. No. 2015/06942, filed Sep. 17, 2015, the entirety of each of the above reference applications are hereby incorporated by reference in their entirety.

### BACKGROUND OF THE INVENTION

The present application relates to a system and a method of dynamically adjusting an annuity based on wellness monitoring of a participant.

### SUMMARY OF THE INVENTION

Disclosed is a computer-system, a computer program product and a method for dynamic adjustment of an annuity based on wellness monitoring of a participant. The process begins with operating an investment plan in which a person invests a capital amount and receives a selected periodic payment amount to be paid out to them and where the capital amount is invested in an underlying asset on behalf of the person. The investment data is accessed including capital amount data relating to a capital amount to be invested for the person, investment selection data relating to an investment selection of how the capital amount is to be invested, and periodic payment amount relating to the selected periodic payment amount to be paid to the person. Wellness programme data is accessed from a variety of sources relating to a compliance of the person with a wellness programme, the wellness program data includes a heart rate derived from a heart rate monitor worn by the person, results of health check-ups of the person, a recorded amount and location of exercise of the person, and results of preventative screening of the person. The wellness programme data is used to dynamically calculate an additional payment amount to be added to the periodic payment amount to the person wherein an amount of the compliance of the person with the wellness programme is directly related to the additional payment amount to be paid to the person.

In one example, the wellness program data includes data on good driving recorded by an automobile.

In another example, the wellness program data includes data of food purchased by the person.

According to another example embodiment there is provided a method of operating an investment plan based on engagement with a wellness programme, the investment plan of the kind in which a person invests a capital amount and receives a selected periodic amount to be paid out to them and where the capital amount is invested in an underlying asset on behalf of the person, the method including:
receiving and storing investment data including capital amount data relating to a capital amount to be invested for a person, investment selection data relating to an investment selection of how the capital amount is to be invested, and periodic payment data relating to a selected periodic payment amount to be paid to the person;
receiving and storing wellness programme data relating to the compliance of the person with a wellness programme;
using the stored wellness data to calculate an additional payment amount to be added to the periodic payment amount to the person wherein the better the compliance of the person with the wellness programme the larger the additional payment amount to be paid to the person.

The method preferably includes also using the selected periodic payment to calculate the additional payment amount wherein the lower the selected periodic payment the larger the additional payment amount to be paid to the person.

In one example, the method further includes defining different percentage levels which are percentages of the capital amount invested wherein the selected periodic payment amount is a selected percentage level.

The method preferably includes also using the selected percentage level to calculate the additional payment amount wherein the lower the percentage level the larger the additional payment amount to be paid to the person.

According to another example embodiment, a system for operating an investment plan based on engagement with a wellness programme, the investment plan of the kind in which a person invests a capital amount and receives a selected periodic amount to be paid out to them and where the capital amount is invested in an underlying asset on behalf of the person, the system including:
a monitoring module to monitor the compliance of a person with a wellness programme;
a communications module for receiving investment data including capital amount data relating to a capital amount to be invested for a person, investment selection data relating to an investment selection of how the capital amount is to be invested, and periodic payment data relating to a selected periodic payment amount to be paid to the person;
a database for storing investment data and wellness data; and
a calculation module to use the stored investment data and wellness data to calculate an additional payment amount to be added to the periodic payment amount to the person wherein the better the compliance of the person with the wellness programme the larger the additional payment amount to be paid to the person.

The calculation module may further also use the selected periodic payment to calculate the additional payment amount wherein the lower the selected periodic payment the larger the additional payment amount to be paid to the person.

In one example, the calculation module further defines different percentage levels which are percentages of the capital amount invested and wherein the selected periodic payment amount is a selected percentage level.

In addition, the calculation module uses the selected percentage level to calculate the additional payment amount wherein the lower the percentage level the larger the additional payment amount to be paid to the person.

According to another example embodiment there is provided a method of operating an investment plan based on engagement with a wellness programme, the investment plan of the kind in which a person invests a capital amount and receives a selected periodic amount to be paid out to them and where the capital amount is invested in an underlying asset on behalf of the person, the method including:
receiving and storing investment data including capital amount data relating to a capital amount to be invested for a person, investment selection data relating to an investment selection of how the capital amount is to be invested, and periodic payment data relating to a selected periodic payment amount to be paid to the person;
receiving and storing wellness programme data relating to the compliance of the person with a wellness programme;
using the stored wellness data and investment data to calculate a reward for the person, wherein:
   i. the better the compliance of the person with the wellness programme the larger the reward;
   ii. the lower the selected periodic payment the larger the reward; and
   iii. the larger the selected percentage of the capital amount to be invested with investments of the investment plan managers the larger the reward.

### BRIEF DESCRIPTION OF THE DRAWINGS

FIG. 1 is a block diagram illustrating an example system to implement the methodologies described herein; and

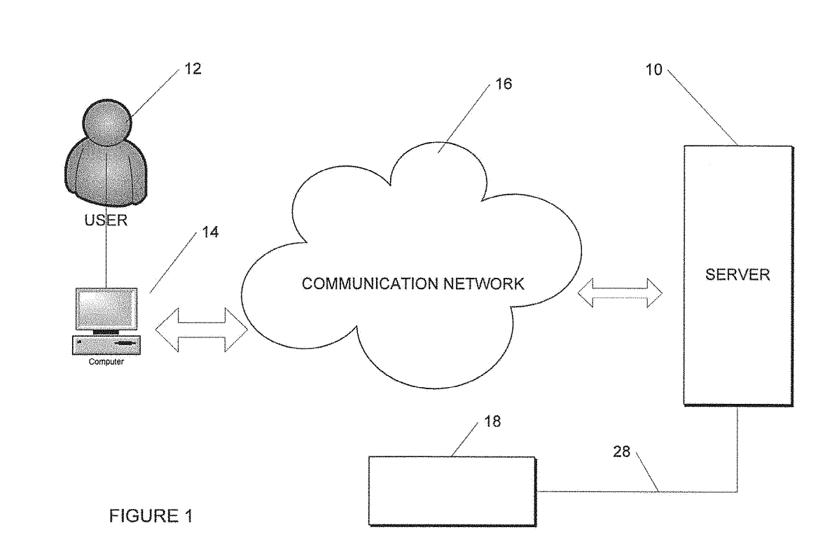

FIG. 2 is a block diagram illustrating an example server in more detail.

FIG. 3 is a diagram illustrating various systems being accessed used to calculate the income boost.

FIG. 4 is a diagram illustrating an over-all flow of dynamic adjustment of an annuity based on wellness monitoring of a participant.

### DESCRIPTION OF EMBODIMENTS

The systems and methodology described herein relate to a system and method of operating an investment plan based on engagement with a wellness programme.

The investment plan in one example embodiment is of the kind in which a person invests a capital amount and receives a selected periodic amount to be paid out to them. The capital amount is invested in an underlying asset on behalf of the person and based in part on the performance of the underlying asset the periodic amount will be altered.

It will be appreciated that the present invention could equally be implemented with other sorts of investment plans

The present invention includes an incentive program to encourage participants to withdraw lower amounts of their capital and get healthier. This in turn increases the likelihood of assets staying invested for longer with an investment fund, such as Discovery Funds with an online URL found here <https://www.discovery.co.za/portal/>, which in turn improves profitability of the investment fund/

Referring to the accompanying figures, the compliance of a person (who in this case is also an insured life on a life insurance plan) with a wellness programme is monitored.

An example of such a wellness program is presently managed by the applicant and is disclosed in the applicant's South African granted patent number ZA 99/1746, the contents of which are incorporated herein by reference in its entirety.

In an example wellness program, users participate in approved related facilities and/or services, for example gymnasiums, Smoke Enders™ and Weighless™.

Thus examples of compliance with a wellness program might include:
Compliance with a fitness programme;
Weight loss programme compliance;
Smoking cessation;
The purchase of healthy food products; and
The compliance with drug regimes.

In one example, users 12 are awarded points and depending on the total number of points allocated to a user, they fall within one of five statuses. In the implementation of the wellness program, these statuses have been named in ascending order of value, blue, bronze, silver, gold and diamond. All users 12 are placed initially in the blue status. Once a person has accumulated a predetermined number of points, his/her status is upgraded to the next appropriate level.

It will be appreciated that for purposes of the present invention the wellness programme could be operated by the investment services provider or could be operated by a third party that operates the wellness programme and then informs the credit provider of the degree of participation of the person with the wellness programme.

This could occur by a third party 18 transmitting data to at least one server 10 operated by the investment services provider. The data is received at the server 10 and stored in a database 20 associated with the at least one server.

In one example the data will include at least an identity of the person and data identifying the status of the person, for example blue, bronze, silver, gold and diamond.

In order to determine the status, a monitoring of the compliance of the person with the wellness programme includes receiving usage information associated with the person's usage of the wellness program and determining, based on the usage information, a status level associated with the person for the wellness program, wherein the status level indicates a degree of participation in the wellness program

The usage information received may include information associated with a plurality of separate and distinct occurrences of wellness program participation by the person.

In an alternative embodiment, the method may further include determining a status level associated with the person that further includes receiving the usage information from an information processing system and assigning a given point value to each separate and distinct occurrence of wellness program participation.

A total point value is determined based on an accumulation of each given point value assigned to each separate and distinct occurrence of wellness program participation

The total point value is then compared to a plurality of point ranges, each point range in the plurality of point ranges being associated with a status level and identifying a point range in the plurality of point ranges corresponding to the total point value.

Finally, a status level is assigned that is associated with the point range that has been identified to the person.

Data relating to the compliance of the person with the wellness programme is stored in the database 20.

In one example embodiment, the stored wellness data is used as one factor to calculate an additional payment amount.

The stored wellness data and is used to calculate an additional payment amount to be added to the periodic payment amount to the person wherein the better the compliance of the person with the wellness programme the larger the additional payment amount to be paid to the person.

In one example embodiment the method is implemented as a boost to the person's retirement income for 10 years is provided as and when income is drawn out of their linked retirement income plan.

The boost percentage will vary and will depend on one or more of the following:
Annual percentage drawdown for the year (set on each policy anniversary date)
Vitality status at the time of each income payment
Proportion of investment in qualifying Discovery funds at the time of each payment

The Vitality status is determined by points which are earned through factors such as average heart rate in exercise sessions versus maximum levels per age which can only be determined by sophisticated devices, adherence to wellness programs, number of gym visits and exercise sessions and preventative screenings amongst others.

An individual will set their level of income for each year on the policy anniversary date. The level of income required may be expressed as a:
Fixed rand amount per income payment frequency (equal to an annual drawdown percentage of between 2.5% and 17.5% of the investment value at the policy anniversary date)
Annual drawdown percentage between 2.5% and 17.5% per annum of the investment value at the policy anniversary date

Where a fixed rand amount is selected, this must be converted into the equivalent annual drawdown percentage in order to calculate the additional payment amount. To do this, the following variables are defined:
Fund (t)=fund value as at the t^{th} policy anniversary
   t=0, 1, 2, . . . .
Freq (t)=income frequency chosen at the t^{th} policy anniversary t=0, 1, 2, . . . .

Annual Drawdown Percentage

$$( t ) = \frac{Fixed rand amount per income payment frequency \times Freq ( t )}{Fund ( t )}$$

The income boost percentage will be determined using the above annual drawdown percentage for the year, and the Vitality status and qualifying Discovery Fund percentage at the time of each income payment.

To calculate the income boost percentages in policy year t, we define the following variables:
IB (t, i)=income boost lookup from the Retirement Income Booster matrix for the i^{th} income payment in policy year t.

This will depend on the drawdown band that the person's Annual Drawdown Percentage (calculated at the start of each year) falls into and their Vitality status at the time of the i^{th} income payment, according to the matrix below.
DF % (t, i)=percentage invested in qualifying Discovery Funds in policy year t at the time the i^{th} income payment

The following matrix will be used to determine the income boost lookup (IB) for a given income payment:

Retirement Income Booster

| Drawdown | Vitality Status | | | | | |
|---|---|---|---|---|---|---|
| bands | None | Blue | Bronze | Silver | Gold | Diamond |
| 2.50%-3.25% | 20.00% | 30.00% | 35.00% | 40.00% | 45.00% | 50.00% |
| 3.26%-4.00% | 15.00% | 17.50% | 20.00% | 25.00% | 30.00% | 35.00% |
| 4.01%-4.75% | 10.00% | 12.50% | 15.00% | 17.50% | 20.00% | 25.00% |
| 4.76%-5.50% | 5.00% | 7.50% | 10.00% | 12.50% | 15.00% | 17.50% |
| 5.51%-7.00% | 2.50% | 2.50% | 5.00% | 7.50% | 10.00% | 12.50% |
| 7.01%-8.50% | 0.00% | 0.00% | 2.50% | 5.00% | 5.00% | 7.50% |
| 8.51%-10.00% | 0.00% | 0.00% | 0.00% | 2.50% | 2.50% | 5.00% |

It will be appreciated that the person is rewarded even if they have no wellness engagement if they withdraw a lower amount.

It will be appreciated that in this illustrated example, the selected periodic payment is also used to calculate the additional payment and that the lower the selected periodic payment the larger the additional payment amount to be paid to the person.

It will be appreciated that in this illustrated example different percentage levels are defined which are percentages of the capital amount and the selected periodic payment amount is a therefore a selected percentage level.

An example using the above is as follows.

A person invests R 10,000,000 into an invest linked retirement income plan.
80% is invested into qualifying funds.
No initial advice fees charged.
The person is on Bronze Vitality status at policy inception
The person chooses to receive quarterly income in advance of R125,000 for the first policy year.

The calculation of the annual drawdown percentage for the first policy year is as follows:

Fund (0)=R10,000,000

Freq (0)=4

$$Annual Drawdown Percentage ( 0 ) = \frac{125 , 000 \times 4}{10 , 000 , 000} = 5 \%$$

The calculation of the additional payment amount is done as follows.

Assuming a change in Vitality status and qualifying Discovery Fund percentage as shown in the below table, income boost percentages for each quarterly payment in the first policy year will be calculated as follows:

| | Vitality | | | |
|---|---|---|---|---|
| i | Status (1, i) | DF %(1, i) | IB(1, i) | Income Boost Percentage |
| 1 | Bronze | 80% | 10.0% | 10.0% × 80% = 8.0% |
| 2 | Bronze | 85% | 10.0% | 10.0% × 85% = 8.5% |
| 3 | Silver | 85% | 12.5% | 12.5% × 85% = 10.625% |
| 4 | Gold | 75% | 15.0% | 15.0% × 75% = 11.25% |

The client's elected level of income will give the following income boost amounts in the form of additional payment amounts:

Importantly these additional payment amounts are not withdrawn from the client's investment but are purely additive and funded by fund managers.

It will be appreciated that this extra payment would be of no value if the extra income was coming from the client's investment.

| i | Income Payment (1, i) | Income Boost Amount |
|---|---|---|
| 1 | R125,000 | R125,000 × 8.0% = R10,000 |
| 2 | R125,000 | R125,000 × 8.5% = R10,625 |
| 3 | R125,000 | R125,000 × 10.625% = R13,281.25 |
| 4 | R125,000 | R125,000 × 11.25% = R14,062.50 |

It will be appreciated that in the above example all three factors of Vitality Status, fund selected and percentage drawdown for the year have been used whereas in alternative embodiments one or more of these may be used to calculate the additional payment amounts.

In an alternative embodiment, these mechanisms (income drawdowns, Vitality status, Discovery Funds) could also give benefits in other forms.

For example, instead of boosting the income, the person may be rewarded with one or more of the following:

1) Discounted fees on their investments

2) Boosts to their initial lump sum that pay out over time depending on clients maintaining the right behavior

3) Benefits outside of the investment itself that link back—perhaps discounts at certain health partners or flights, etc.

One example embodiment of implementing this would be using the stored wellness data and investment data to calculate a reward for the person, wherein:
i. the better the compliance of the person with the wellness programme the larger the reward;
ii. the lower the selected periodic payment the larger the reward; and
iii. the larger a selected percentage of the capital amount to be invested with investments managed by the investment plan managers the larger the reward.

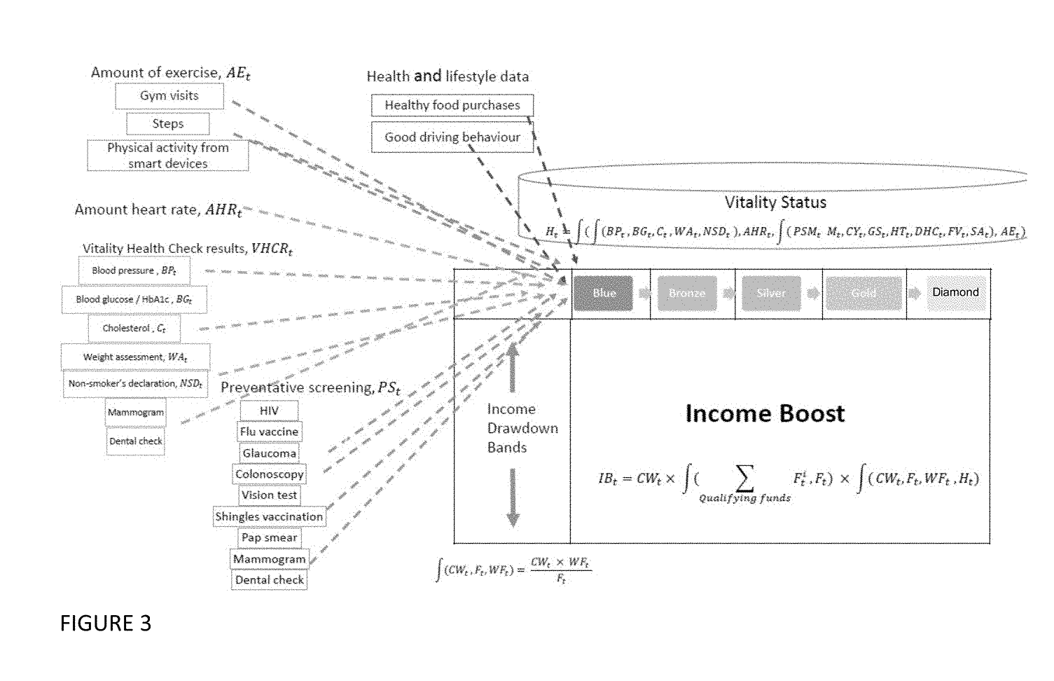

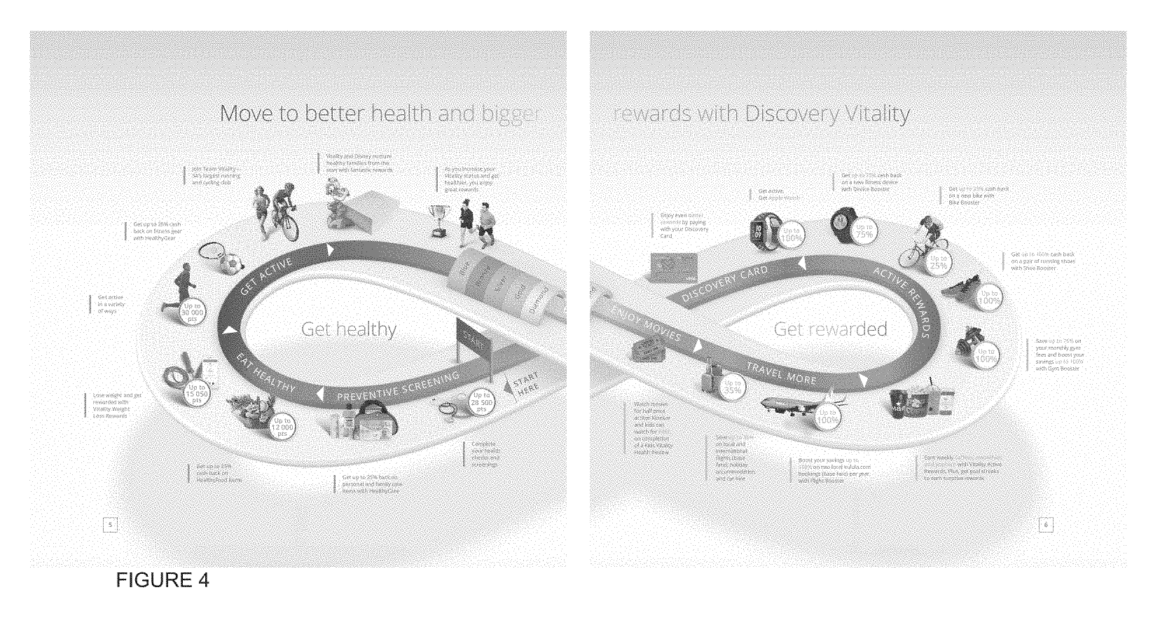

The following is another example of Income Boost which is calculated dynamically by accessing data from multiple systems in accordance with FIG. 3 and FIG. 4 is a diagram illustrating an over-all flow of dynamic adjustment of an annuity based on wellness monitoring of a participant.

$${IB}_{t} = {CW}_{t} \times \int ( {\sum }_{Qualifying funds} {F}_{t}^{i} , {F}_{t} ) \times \int ( {CW}_{t} , {F}_{t} , {WF}_{t} , {H}_{t} )$$

The income boost is a product of 3 items:
1. The chosen withdrawal amount, CWₜ
2. The proportion of the client's funds invested in qualifying Discovery funds. This is a function of:
   a. The client's total fund balance within the linked retirement income plan, Fₜ
   b. The total amount of the clients funds that are invested in qualifying funds, Σ_{Qualifying funds} Fₜⁱ

$$\int ( {\sum }_{Qualifying funds} {F}_{t}^{i} , {F}_{t} ) = \frac{{Σ}_{Qualifying funds} {F}_{t}^{i}}{{F}_{t}}$$

3. The client's qualifying boost percentage. This is a function of:
   a. The client's health status, Hₜ, as measured by their Vitality status
      The client's health status is a function of:
         Earned points in the Vitality programme, EPₜ
         EPₜ are earned through factors such as:
         i. The client's Vitality Health Check results, VHCRₜ determined by the client's:
         01|Blood pressure, BPₜ
         02|Blood glucose/HbA1c, BGₜ
         03|Cholesterol, Cₜ
         04|Weight assessment, WAₜ
         05|Non-smoker's declaration, NSDₜ

VHCRₜ=∫(BPₜ,BGₜ,Cₜ,WAₜ,NSDₜ)
ii. Average heart rate in exercise sessions, **subject to maximum levels per age, AHRₜ
iii. Preventative screenings, PSₜ
determined by factors such as:
01|Pap smear, PSMₜ
02|Mammogram, Mₜ
03|Colonoscopy, CYₜ
04|Glaucoma screening, GSₜ
05|HIV test, HTₜ
06|Dental Health Check, DHCₜ
07|Flu vaccination, FVₜ
08|Senior activities, SAₜ

PSₜ=∫(PSMₜ,Mₜ,CYₜ,GSₜ,HTₜ,DHCₜ,FVₜ,SAₜ)
iv. The client's amount of exercise, AEₜ
determined by:

Hₜ=∫(EPₜ)

Hₜ=∫(VHCRₜ,AHRₜ,PS_{L},AEₜ)

Hₜ=∫(∫(BPₜ,BGₜ,Cₜ,WAₜ,NSDₜ),AHRₜ,∫(PSMₜ,Mₜ,CYₜ,GSₜ,HTₜ,DHCₜ,FVₜ,SA_{L}),AEₜ)
b. The client's annual withdrawal percentage which is a function given by:

$$\int ( {CW}_{t} , {F}_{t} , {WF}_{t} ) = \frac{{CW}_{t} \times {WF}_{t}}{{F}_{t}}$$

The client's annual withdrawal percentage is used together with the client's Vitality status to look up the boost % using the table below:

As shown in FIG. 3 and FIG. 4, the system accesses wellness programme data from a variety of sources relating to a compliance of the person with a wellness programme. The wellness program data includes a heart rate derived from a heart rate monitor worn by the person. Examples of monitors include watches and smart phones connected to one or more wireless sensors. The sensors can monitor other health related data besides heart rate including blood glucose, cholesterol, weight, smoking and more. The wellness program data includes accessing results of health check-ups of the person which may be tied to other databases or devices. Further the wellness program data includes accessing a recorded amount and location of exercise of the person. Knowing the location of a person helps with verifying the participation in certain activities whether indoor or out including running, biking, swimming, and participation in health related facilities. The wellness programme data also includes the results of preventative screening of the person. The wellness programme data is used to dynamically calculate an additional payment amount to be added to the periodic payment amount to the person wherein an amount of the compliance of the person with the wellness programme is directly related to the additional payment amount to be paid to the person.

In one example, the wellness program data includes data on good driving recorded by an automobile. This may be the speed versus posted speeds. How quickly the person accelerates or decelerates. The congestion on the road and average time of commute may also be used.

In another example, the wellness program data includes data of food purchased by the person. The location of the food purchase may be used to verify the type of food and the frequency of food purchased.

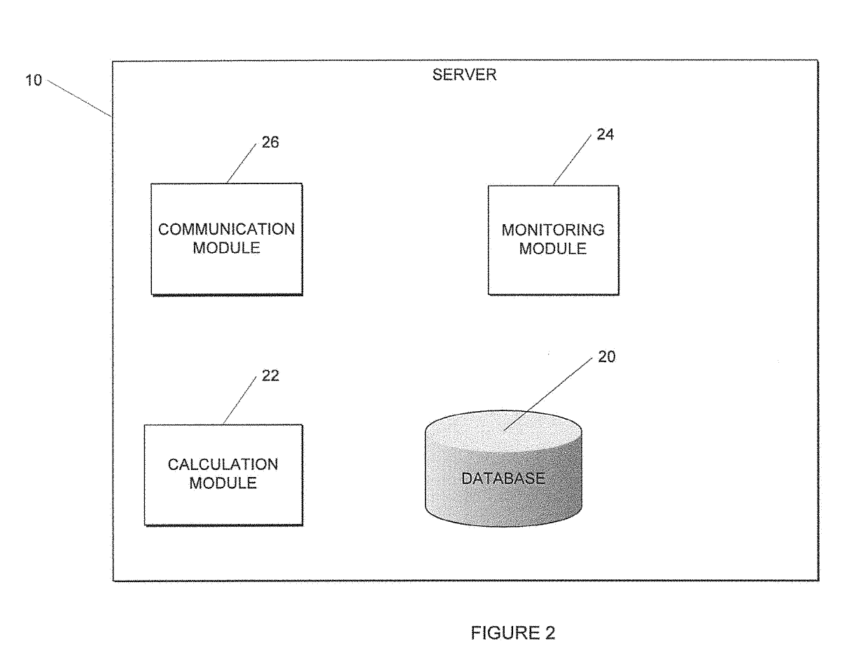

FIG. 2 illustrates an exemplary system for implementing the above methodologies.

A server 10 includes a number of modules to implement the methodologies described above.

A monitoring module 24 is specifically constructed to define a wellness programme and monitor the compliance of the wellness programme by the person.

The monitoring of the compliance of the person with the wellness programme includes receiving by the communication module 26, usage information associated with the person's usage of the wellness programme.

The usage information received may include information associated with a plurality of separate and distinct occurrences of wellness programme participation by the person.

The monitoring module 24 determines, based on the usage information, a points value or a status level associated with the person for the wellness programme, wherein the points value or the status level indicates a degree of participation in the wellness programme.

In addition, the monitoring module 24 may further be constructed to determine a status level associated with the person by receiving the usage information from an information processing system and assigning a given point value to each separate and distinct occurrence of wellness programme participation.

A total point value is determined by the monitoring module 24 based on an accumulation of each given point value assigned to each separate and distinct occurrence of wellness programme participation

The total point value is then compared to a plurality of point ranges by the monitoring module 24 each point range in the plurality of point ranges being associated with a status level and identifying a point range in the plurality of point ranges corresponding to the total point value.

Finally, a status level is assigned by the monitoring module 24 that is associated with the point range that has been identified to the at least one employee.

The monitoring module 24 then writes the total points value or the status level to a memory, for example the database 20.

In either case the calculation module 22 accesses the memory and retrieves the stored total points value or status level.

The calculation module 22 is constructed to calculate the refund amount as described above.

As mentioned above, the system includes at least one associated database 20 for storing data to be used by one or more of the above referenced modules.

In addition, the server is typically connected to a communications network 28 for communications with other computers to implement the methodologies described above.

The server 10 may also be connected to another communications network in the form of the Internet 16 so that persons 12 are able to access the server and obtain information either about their wellness status or the additional payment amount.

In addition, users may be allowed, via this communications network to access questionnaires over the Internet 16 using a computer 14 whereby their answers to these questions could be used as part of the wellness programme compliance assessment.

The modules described above may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

In another example embodiment the modules may be implemented using firmware programmed specifically to execute the method described herein.

It will also be appreciated that in any of these cases the modules form a physical apparatus with physical modules specifically for executing the steps of the method described herein.

What is claimed is:

1. A computer-implemented method for dynamic adjustment of an annuity based on wellness monitoring of a participant, the computer-implemented method comprising:
operating an investment plan in which a person invests a capital amount and receives a selected periodic payment amount to be paid out to them and where the capital amount is invested in an underlying asset on behalf of the person;
accessing investment data including capital amount data relating to a capital amount to be invested for the person, investment selection data relating to an investment selection of how the capital amount is to be invested, and periodic payment amount relating to the selected periodic payment amount to be paid to the person;
accessing wellness programme data from a variety of sources relating to a compliance of the person with a wellness programme, the wellness program data includes a heart rate derived from a heart rate monitor worn by the person, results of health check-ups of the person, a recorded amount and location of exercise of the person, and results of preventative screening of the person; and
using the wellness programme data to dynamically calculate an additional payment amount to be added to the periodic payment amount to the person wherein an amount of the compliance of the person with the wellness programme is directly related to the additional payment amount to be paid to the person.

2. The computer-implemented method according to claim 1, further including also using the selected periodic payment amount to calculate the additional payment amount wherein the lower the selected periodic payment amount the larger the additional payment amount to be paid to the person.

3. The computer-implemented method according to claim 1, wherein the method further includes defining different percentage levels which are percentages of the capital amount invested wherein the selected periodic payment amount is a selected percentage level.

4. The computer-implemented method according to claim 2, wherein the method further includes defining different percentage levels which are percentages of the capital amount invested wherein the selected periodic payment amount is a selected percentage level.

5. The computer-implemented method according to claim 3 wherein the method includes using the selected percentage level to calculate the additional payment amount wherein the lower the percentage level the larger the additional payment amount to be paid to the person.

6. The computer-implemented method according to claim 1, further including also using the selected periodic payment to calculate the additional payment amount wherein the lower the selected periodic payment the larger the additional payment amount to be paid to the person.

7. The computer-implemented method according to claim 1, further including also using the selected periodic payment amount to calculate the additional payment amount wherein the lower the selected periodic amount payment the larger the additional payment amount to be paid to the person.

8. The computer-implemented method according to claim 1, wherein the wellness program data includes data on good driving recorded by an automobile.

9. The computer-implemented method according to claim 1, wherein the wellness program data includes data of food purchased by the person.

10. A computer system for dynamic adjustment of an annuity based on wellness monitoring of a participant operating an investment plan based on engagement with a wellness programme, the system including:
a communications module for operating an investment plan in which a person invests a capital amount and receives a selected periodic payment amount to be paid out to them and where the capital amount is invested in an underlying asset on behalf of the person and for accessing investment data including capital amount data relating to a capital amount to be invested for the person, investment selection data relating to an investment selection of how the capital amount is to be invested, and periodic payment amount relating to the selected periodic payment amount to be paid to the person;
at least one sensor that captures heart rate of a person;
a monitoring module to monitor wellness programme data from a variety of sources relating to a compliance of the person with a wellness programme, the wellness program data includes a heart rate derived from the at least one sensor worn by the person, results of health check-ups of the person, a recorded amount and location of exercise of the person, and results of preventative screening of the person; and
a database for storing the investment data and the wellness programme data; and
a calculation module to use the stored investment data and wellness programme data to dynamically calculate an additional payment amount to be added to the periodic payment amount to the person wherein an amount of the compliance of the person with the wellness programme is directly related to the additional payment amount to be paid to the person.

11. The computer system according to claim 10, further including also using the selected periodic payment amount to calculate the additional payment amount wherein the lower the selected periodic payment amount the larger the additional payment amount to be paid to the person.

12. The computer system according to claim 10, wherein the calculation module further includes defining different percentage levels which are percentages of the capital amount invested wherein the selected periodic payment amount is a selected percentage level.

13. The computer system according to claim 11, wherein the calculation module further includes defining different percentage levels which are percentages of the capital amount invested wherein the selected periodic payment amount is a selected percentage level.

14. The computer system according to claim 12, wherein the calculations module includes using the selected percentage level to calculate the additional payment amount wherein the lower the percentage level the larger the additional payment amount to be paid to the person.

15. The computer system according to claim 10, further including also using the selected periodic payment to calculate the additional payment amount wherein the lower the selected periodic payment the larger the additional payment amount to be paid to the person.

16. The computer system according to claim 10, further including also using the selected periodic payment amount to calculate the additional payment amount wherein the lower the selected periodic amount payment the larger the additional payment amount to be paid to the person.

17. The computer system according to claim 10, wherein the wellness program data includes data on good driving recorded by an automobile.

18. The computer system according to claim 10, wherein the wellness program data includes data of food purchased by the person.

19. A computer program product for dynamic adjustment of an annuity based on wellness monitoring of a participant, the computer program product comprising:
a non-transitory storage medium, readable by a processing circuit and storing instructions for execution by the processing circuit for performing a method comprising:
operating an investment plan in which a person invests a capital amount and receives a selected periodic payment amount to be paid out to them and where the capital amount is invested in an underlying asset on behalf of the person;
accessing investment data including capital amount data relating to a capital amount to be invested for the person, investment selection data relating to an investment selection of how the capital amount is to be invested, and periodic payment amount relating to the selected periodic payment amount to be paid to the person;
accessing wellness programme data from a variety of sources relating to a compliance of the person with a wellness programme, the wellness program data includes a heart rate derived from a heart rate monitor worn by the person, results of health check-ups of the person, a recorded amount and location of exercise of the person, and results of preventative screening of the person; and
using the wellness programme data to dynamically calculate an additional payment amount to be added to the periodic payment amount to the person wherein an amount of the compliance of the person with the wellness programme is directly related to the additional payment amount to be paid to the person.

20. The computer program product according to claim 19, further including also using the selected periodic payment amount to calculate the additional payment amount wherein the lower the selected periodic payment amount the larger the additional payment amount to be paid to the person.
